(19) United States
(12) Patent Application Publication
(10) Pub. No.: US 2023/0227137 A1
(43) Pub. Date: Jul. 20, 2023

(54) Underwater Remote Cleaning System

(71) Applicants: Richard Lee Glenn, Charlotte, NC (US); Ryan Lee Glenn, Charlotte, NC (US)

(72) Inventors: Richard Lee Glenn, Charlotte, NC (US); Ryan Lee Glenn, Charlotte, NC (US)

(21) Appl. No.: 17/580,111

(22) Filed: Jan. 20, 2022

(51) Int. Cl. B63G 8/00; B05B 1/00; B05B 9/04; B05B 15/68; B08B 5/02; B63B 59/08

(52) U.S. Cl. CPC B63G 8/001; B05B 1/005; B05B 9/0403; B05B 15/68; B08B 5/02; B63B 59/08; B63G 2008/007

(57) ABSTRACT

An underwater remote cleaning device includes a submersible assembly, a cleaning conduit, and a thruster conduit. The submersible assembly has an upper frame and a lower frame spaced-apart from each other and at least one vertically extending element having a first end and a second end. The first end of the vertically extending element is engaged to the upper frame and the second end of the vertically extending element is engaged to the lower frame. The cleaning conduit is disposed within the submersible assembly with an inlet for receiving a liquid and at least one nozzle disposed on the cleaning conduit for spraying the liquid. The thruster conduit is disposed within the submersible assembly with an inlet for receiving a liquid and at least one nozzle disposed on the cleaning conduit for spraying the liquid.

### FIELD OF THE INVENTION

The present invention relates generally to an underwater remote cleaning device for cleaning structures or objects below the surface of a body of water, and more generally relates to an underwater remote cleaning device that includes a submersible assembly that uses high pressure water to clean structures and objects located below the surface of a body of water.

### BACKGROUND OF THE INVENTION

It is difficult to clean structures that are submerged underwater. It is exceedingly more difficult to clean structures that are submerged in deep water such as an ocean, lake, or river. Such structures may include dams, pilings, and the like that are permanently submerged underwater without the ability to remove from the water for cleaning. It is an object of the present invention to provide a device that can be used to remotely clean structures submerged underwater.

### BRIEF SUMMARY OF THE INVENTION

According to an embodiment of the present invention, an underwater remote cleaning device that includes a submersible assembly, a cleaning conduit, and a thruster conduit. The cleaning conduit is engaged to the submersible assembly with an inlet for receiving a liquid and at least one nozzle disposed on the cleaning conduit for spraying the liquid. The thruster conduit is engaged to the submersible assembly with an inlet for receiving a liquid and at least one nozzle disposed on the cleaning conduit for spraying the liquid.

According to another embodiment of the present invention, the underwater remote cleaning device includes a positioning cable engaged to the submersible assembly with a stabilizing weight engaged to one end of the positioning cable.

According to yet another embodiment of the present invention, the underwater remote cleaning device includes a first positioning cable and a second positioning cable engaged to the submersible assembly, wherein the first positioning cable and the second positioning cable are engaged to a stabilizing weight at one end of the positioning cable.

According to yet another embodiment of the present invention, the underwater remote cleaning device includes at least one bracket engaged to the submersible assembly for receiving a cable for lifting the submersible assembly in the vertical direction.

According to yet another embodiment of the present invention, the underwater remote cleaning device includes an adjustment mechanism disposed on an end of the cleaning conduit, allowing the spray angle of the nozzles to be adjusted relative to the submersible assembly.

According to yet another embodiment of the present invention, the underwater remote cleaning device includes an adjustment mechanism disposed on an end of the thruster conduit, allowing the spray angle of the nozzles to be adjusted relative to the submersible assembly.

According to yet another embodiment of the present invention, the underwater remote cleaning device includes a first high pressure hose engaged to the inlet of the cleaning conduit carrying the liquid and a second high pressure hose engaged to the inlet of the thruster conduit carrying the liquid.

According to yet another embodiment of the present invention, the underwater remote cleaning device includes at least one camera engaged to the submersible assembly.

According to yet another embodiment of the present invention, the underwater remote cleaning device includes a submersible assembly, a cleaning conduit, and a thruster conduit. The submersible assembly has an upper frame and a lower frame spaced-apart from each other and at least one vertically extending element having a first end and a second end. The first end of the vertically extending element is engaged to the upper frame and the second end of the vertically extending element is engaged to the lower frame. The cleaning conduit is disposed within the submersible assembly with an inlet for receiving a liquid and at least one nozzle disposed on the cleaning conduit for spraying the liquid. The thruster conduit is disposed within the submersible assembly with an inlet for receiving a liquid and at least one nozzle disposed on the cleaning conduit for spraying the liquid.

According to yet another embodiment of the present invention, a method for cleaning an underwater structure that includes providing a submersible assembly, a cleaning conduit, and a thruster conduit. The cleaning conduit is engaged to the submersible assembly with an inlet for receiving a liquid and at least one nozzle disposed on the cleaning conduit. The thruster conduit is engaged to the submersible assembly with an inlet for receiving a liquid and at least one nozzle disposed on the cleaning conduit. The submersible assembly is positioned while underwater adjacent a structure to be cleaned. A liquid is supplied to the inlet of the cleaning conduit and the inlet of the thruster conduit. A liquid is sprayed from the nozzle of the cleaning conduit at the underwater structure and the liquid is sprayed from the nozzle of the thruster conduit in a direction opposite the direction of the spray from the cleaning conduit.

### BRIEF DESCRIPTION OF THE DRAWINGS

The present invention is illustrated and described herein with reference to the various drawings, in which like reference numbers denote like method steps and/or system components, respectively, and in which:

FIG. 1 is a perspective view of the underwater remote cleaning device;

FIG. 2 is a perspective view of the underwater remote cleaning device;

FIG. 3 is a perspective view of the underwater remote cleaning device;

FIG. 4 is a side view of the underwater remote cleaning device;

FIG. 5 is a perspective view of the underwater remote cleaning device;

FIG. 6 is a front view of the submersible assembly of the underwater remote cleaning device;

FIG. 7 is a top view of the submersible assembly of the underwater remote cleaning device;

FIG. 8 is a side view of the submersible assembly of the underwater remote cleaning device;

FIG. 9 is a side view of the submersible assembly of the underwater remote cleaning device;

FIG. 10 is a side view of the submersible assembly of the underwater remote cleaning device;

FIG. 11 is a perspective view of the submersible assembly of the underwater remote cleaning device; and

FIG. 12 is a perspective view of the submersible assembly of the underwater remote cleaning device.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

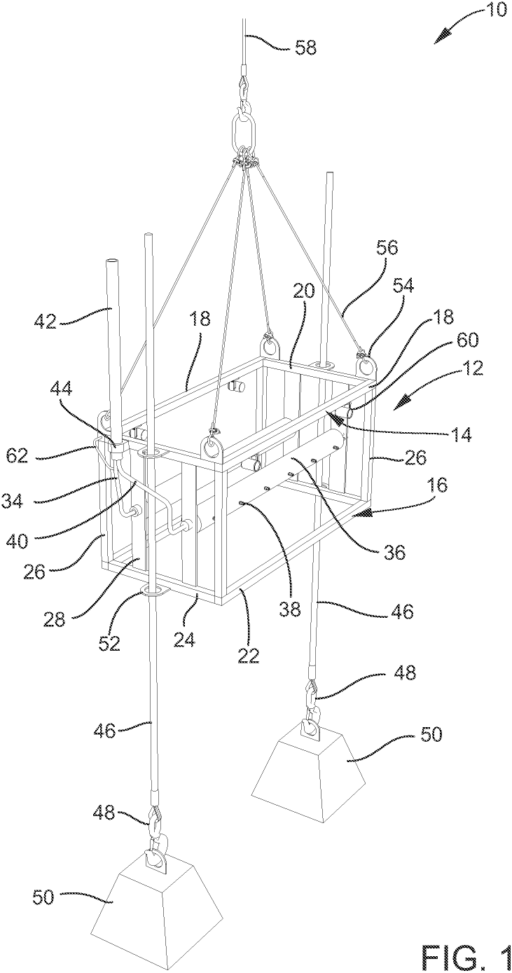

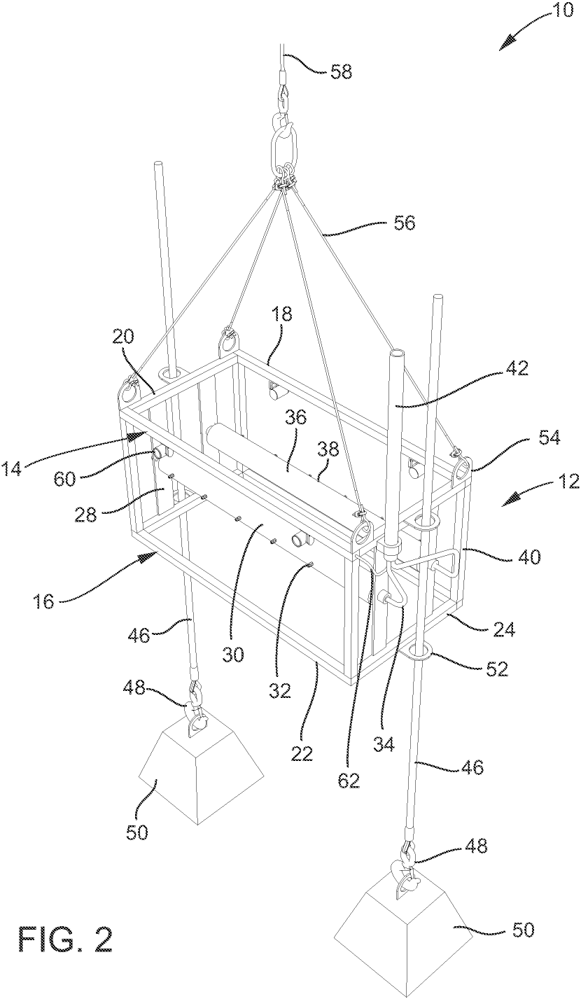

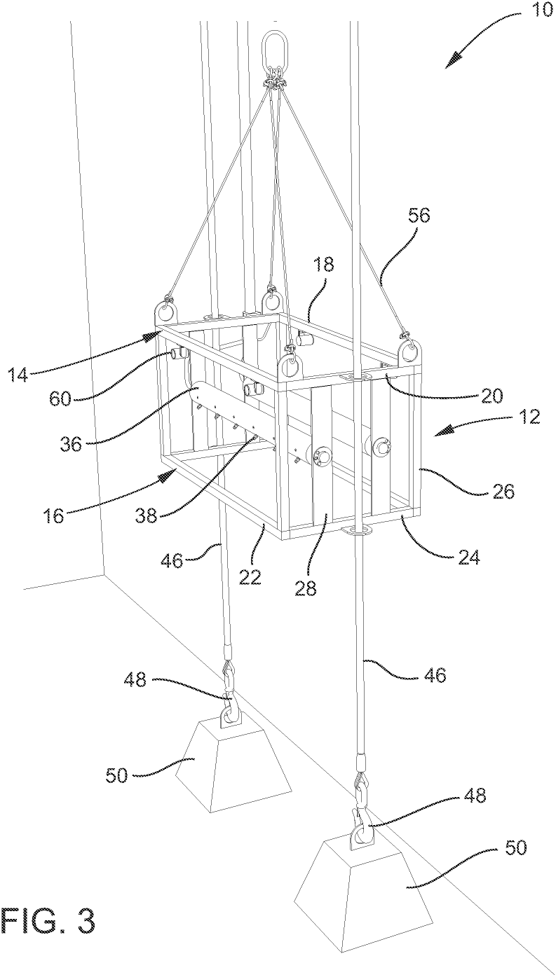

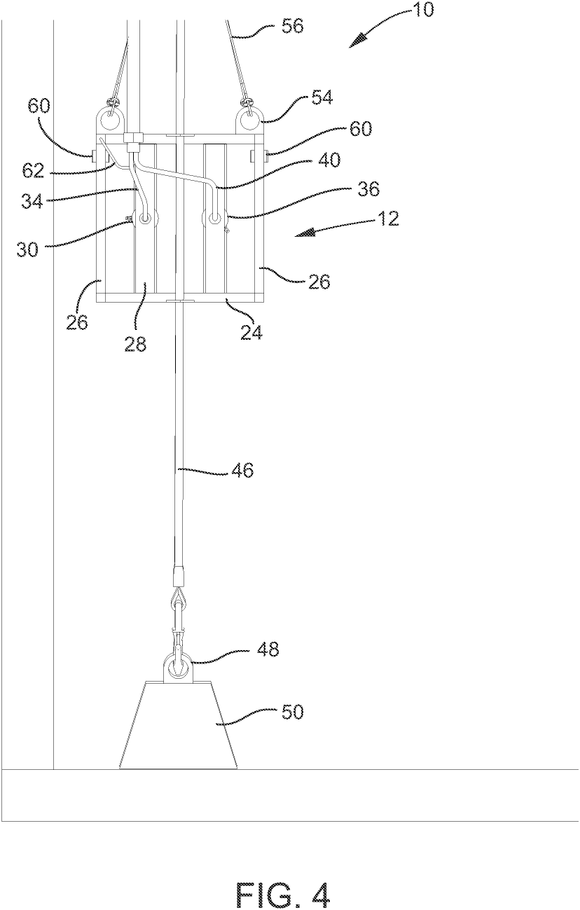

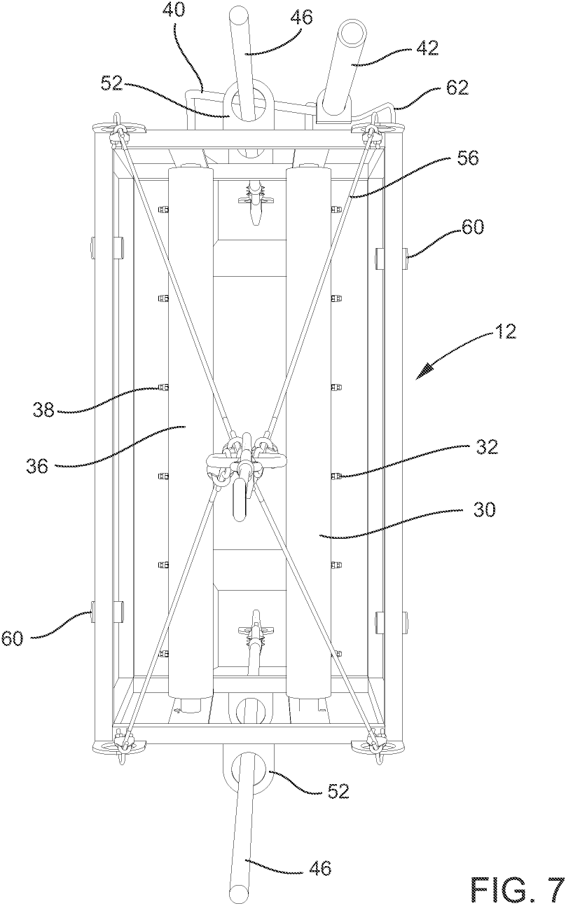

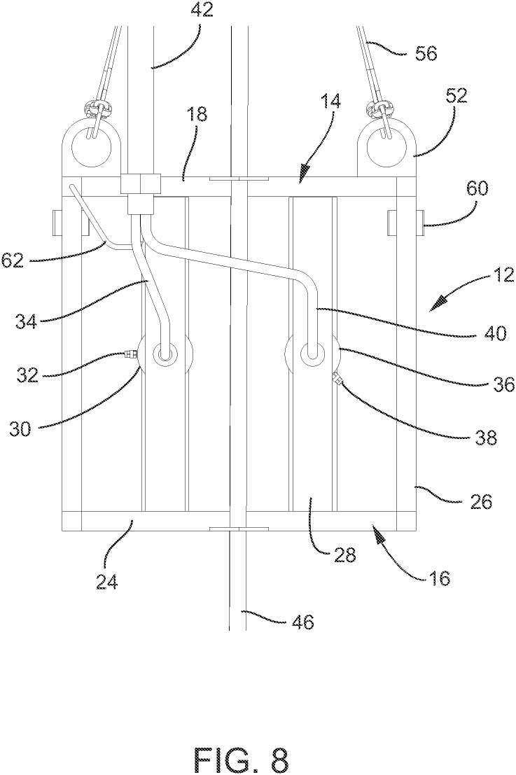

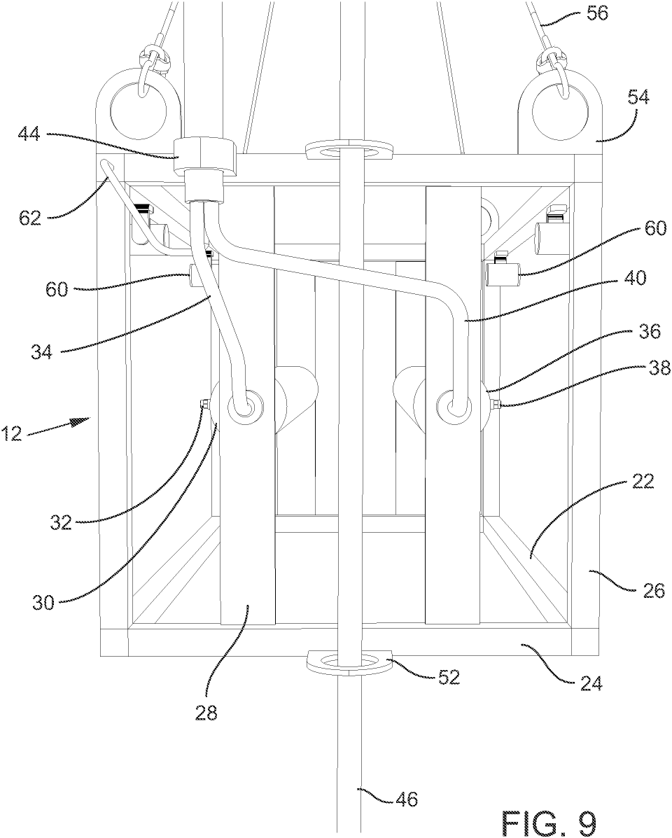

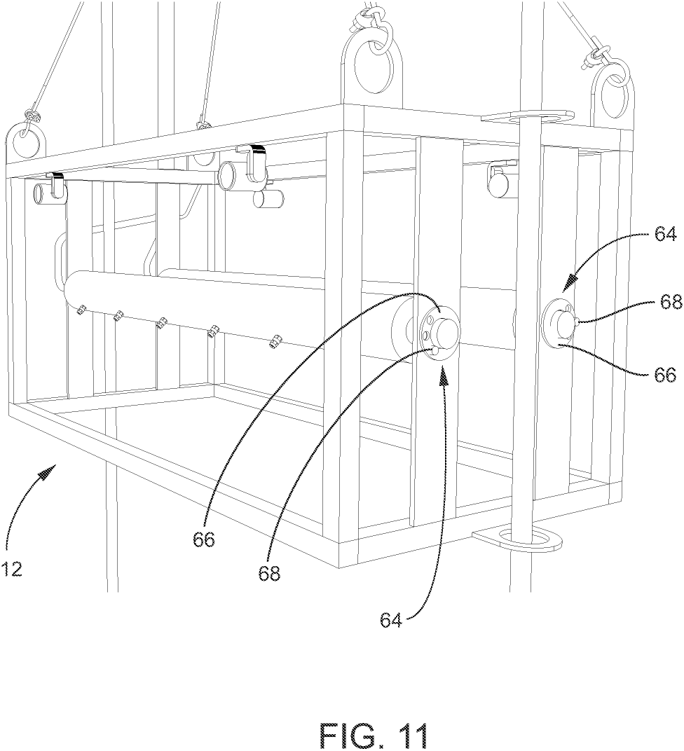

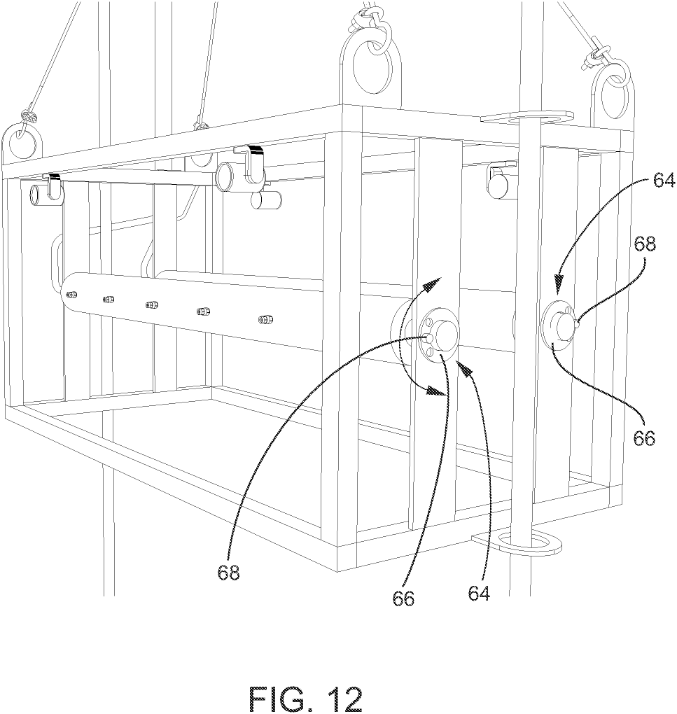

Referring now specifically to the drawings, an underwater remote cleaning device is illustrated in FIGS. 1-12 and is shown generally at reference numeral 10. The device 10 includes a submersible assembly 12 with an upper frame 14 and a lower frame 16. As illustrated, the upper frame 14 and the lower frame 16 have a rectangular shape and substantially identical or similar sizes. While a rectangular shape is illustrated, the upper frame 14 and lower frame 16 may be configured to have other shapes, sizes to accomplish the desired result.

The upper frame 14 has two longitudinal members 18 connected by two transverse members 20 and engaged in a substantially perpendicular relationship between the ends of the longitudinal members 14. As illustrated, the two longitudinal members 18 are connected by two transverse members 20 engaged at substantially right angles between the ends of the longitudinal members 14. The lower frame 16 has two longitudinal members 22 connected by two transverse members 24 and engaged in a substantially perpendicular relationship between the ends of the longitudinal members 22. As illustrated, the two longitudinal members 22 are connected by two transverse members 24 engaged at substantially right angles between the ends of the longitudinal members 22.

The upper frame 14 and the lower frame 16 are connected by vertically extending corner members 26. The corner members 26 have a first end and a second end. The first end of the corner member 26 is engaged to a longitudinal member 18 of the upper frame 14, and the second end of the corner member 26 is engaged to the longitudinal member 18 of the lower frame 16. As illustrated, the submersible assembly 12 comprises four corner members 26, wherein each of the corner members 26 is engaged to an end of each longitudinal member 18 of the upper frame 14 and the corresponding end of the longitudinal member 22 of the lower frame 16. As illustrated, the first end of the corner members 26 are engaged to an end of the longitudinal member 18 of the upper frame 14 and the second end of the corner member 26 is engaged to an end of the longitudinal member 22 of the lower frame 16. It should be noted, the first end of the corner members 26 may be engaged to an end of the transverse member 20 of the upper frame 14 and the second end to an end of the transverse member 24 of the lower frame 16. Alternatively, the first end of the corner members 26 are engaged to both an end of the longitudinal member 18 and an end of the transverse member 20 of the upper frame 14, where the longitudinal member 18 and the transverse member 20 are engaged. The second end of the corner members 26 may be engaged to an end of the longitudinal member 22 and an end of the transverse member 24 of the lower frame 16, where the longitudinal member 22 and the transverse member 24 are engaged.

The upper frame 14 and the lower frame 16 are also connected by a vertically extending element 28 with a first end and a second end, wherein the first end is engaged to the upper frame 14 and the second end is engaged to the lower frame 16. As illustrated, two vertically extending elements 28 are disposed wherein the first ends are engaged to a transverse member 20 of the upper frame 14 and the second ends are engaged to a transverse member 24 of the lower frame 16 and the two vertically extending elements 28 are in a spaced-apart relationship. Two vertically extending elements 28 are disposed on the opposite side of the submersible assembly 12, wherein the first ends are engaged to a transverse member 20 of the upper frame 14 and the second ends are engaged to a transverse member 24 of the lower frame 16 and the two vertically extending elements 28 are in a spaced-apart relationship.

A cleaning conduit 30 is disposed between two of the vertically extending elements 28, wherein a first end of the cleaning conduit 30 is engaged to one vertically extending element 28 and the second end of the cleaning conduit 30 is engaged to an opposed vertically extending element 28. The first end of the cleaning conduit 30 is preferably received within a bore of the adjacent vertically extending element 28 and rotatably coupled to the vertically extending element 28, allowing the first end to rotate within the bore of the vertically extending element 28. The second end of the cleaning conduit 30 is preferably received within a bore of the adjacent vertically extending element 28 and rotatably coupled to the vertically extending element 28, allowing the second end to rotate within the bore of the vertically extending element 28, simultaneously with the rotation of the first end, causing the entire cleaning conduit 30 to rotate. The cleaning conduit 30 includes a barrel shaped body that is cylindrical with an end engaged to the first end and an end engaged to the second end. The diameter of the barrel shaped body is greater than the diameter of the first end and the second end. An intersection is disposed at the transition from the first end and the barrel shaped body and another intersection is disposed at the transition from the second end and the barrel shaped body. The intersection forms an external side surface on each end of the barrel shaped body. The first end, serves as the inlet to the cleaning conduit 30 for receiving a liquid, such as water, from a cleaning conduit high pressure hose 34. A passageway disposed within the first end and the barrel shaped body of the cleaning conduit carries the water from the cleaning conduit high pressure hose 34. The cleaning conduit high pressure hose 34 may be any hose capable of carrying a liquid, such as water, wherein the pressure of the water is at least 1,000 psi. The cleaning conduit high pressure hose 34 utilized in the present invention is preferably able to withstand a pressure of greater than 3,000 psi and more preferably able to withstand a pressure of at least 6,000 psi.

The cleaning conduit 30 comprises at least one support for receiving a cleaning nozzle 32. The support is positioned on the external surface of the barrel shaped body of the cleaning conduit and contains an internal opening that spans from the exit of the support to an entrance to the support, wherein water can flow from the passageway and through the support. Preferably, the cleaning conduit 30 contains two or more, or a plurality of supports. A cleaning nozzle 32 is received within each support. The cleaning nozzle 32 may be integral with the support or selectively secured with the support, allowing a user to easily remove the cleaning nozzle 32 from the support for replacement. The support may be externally threaded for receiving a correspondingly internally threaded cleaning nozzle 32, when the cleaning nozzle 32 is selectively secured to the support.

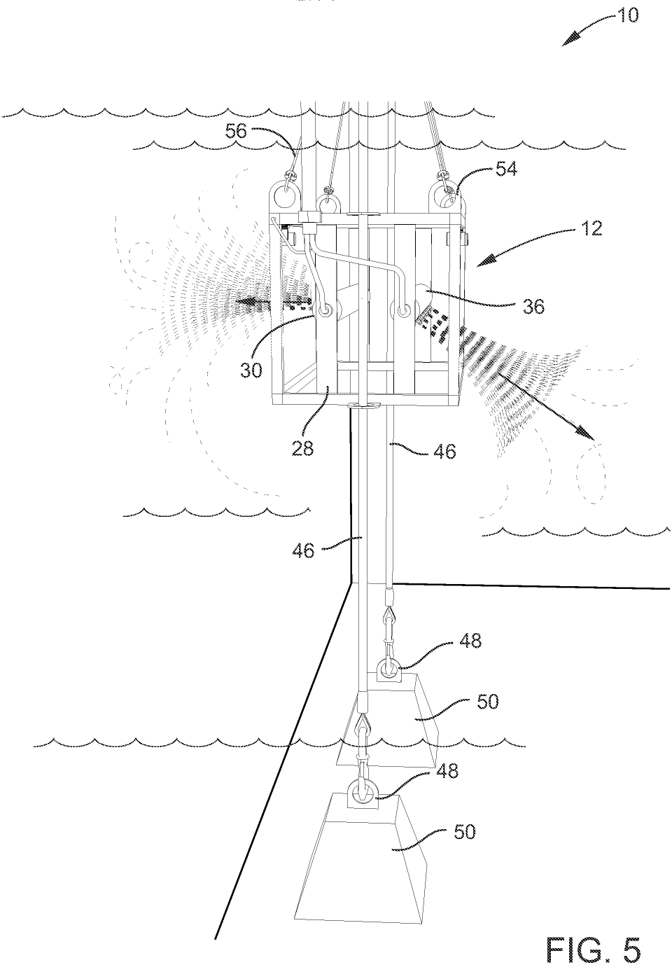

A cleaning conduit high pressure hose 34 is communicatively coupled to the first end, which serves as an inlet of the cleaning conduit 30. The cleaning conduit high pressure hose 34 carries high pressure water to the cleaning conduit 30 that flows through the passageway within the cleaning conduit 30. The passageway directs the water to the supports, where it flows through the opening in the supports, and is forced out of the cleaning nozzles 32 at a high pressure where upon exiting the cleaning nozzles 32 the water may fan out over a predetermined area as shown in FIG. 5 for cleaning an underwater structure.

A thruster conduit 36 is disposed between two of the vertically extending elements 28 that are not carrying the cleaning conduit 30, wherein a first end of the thruster conduit 36 is engaged to one vertically extending element 28 and the second end of the thruster conduit 36 is engaged to an opposed vertically extending element 28. The first end of the thruster conduit 36 is preferably received within a bore of the adjacent vertically extending element 28 and rotatably coupled to the vertically extending element 28, allowing the first end to rotate within the bore of the vertically extending element. The second end of the thruster conduit 36 is preferably received within a bore of the adjacent vertically extending element 28 and rotatably coupled to the vertically extending element 28, allowing the second end to rotate within the bore of the vertically extending element 28, simultaneously with the rotation of the first end, causing the entire cleaning conduit 30 to rotate. The thruster conduit 36 includes a barrel shaped body that is cylindrical with an end engaged to the first end and an end engaged to the second end. The diameter of the barrel shaped body is greater than the diameter of the first end and the second end. An intersection is disposed at the transition from the first end and the barrel shaped body and another intersection is disposed at the transition from the second end and the barrel shaped body. The intersection forms an external side surface on each end of the barrel shaped body. The first end, serves as the inlet to the cleaning conduit 30 for receiving liquid, such as water, from a thruster conduit high pressure hose 40. A passageway disposed within the first end and the barrel shaped body of the cleaning conduit carries the water from the thruster conduit high pressure hose 40. The thruster conduit high pressure hose 40 may be any hose capable of carrying a liquid, wherein the pressure of the water is at least 1,000 psi. The thruster conduit high pressure hose 40 utilized in the present invention is preferably able to withstand a pressure of greater than 3,000 psi and more preferably able to withstand a pressure of at least 6,000 psi.

The thruster conduit 36 contains a passageway therein for allowing high pressure liquid, such as water, to flow therethrough. The thruster conduit 36 comprises at least one support for receiving a thruster nozzle 38. The support is positioned on the external surface of the barrel shaped body of the cleaning conduit and contains an internal opening that spans from the exit of the support to an entrance to the support, wherein water can flow from the passageway and through the support. Preferably, the thruster conduit 36 contains two or more, or a plurality of supports. A thruster nozzle 38 is received within each support. The thruster nozzle 38 may be integral with the support or selectively secured with the support, allowing a user to easily remove the thruster nozzle 38 from the support for replacement. The support may be externally threaded for receiving a correspondingly internally threaded cleaning nozzle 32, when the cleaning nozzle 32 is selectively secured to the support.

A thruster conduit high pressure hose 40 is communicatively coupled to the first end, which serves as an inlet of the thruster conduit 36. The thruster conduit high pressure hose 34 carries high pressure water to the thruster conduit 36 that flows through the passageway within the thruster conduit 36. The passageway directs the water to the supports, where it flows through the opening in the supports, and is forced out of the cleaning nozzles 32 at a high pressure where upon exiting the thruster nozzles 38 the water may fan out over a predetermined area as shown in FIG. 5, creating a force that counteracts the force of the cleaning nozzles 32, stabilizing the submersible assembly 12. In other words, the pressure at which the liquid is discharged from the thruster nozzles 38 is equal to or about the same as the pressure at which the liquid is discharged from the cleaning nozzles 32 to counteract the force exerted on the submersible assembly 12 by the discharge of the liquid from the cleaning nozzles 32 and thus stabilizing the submersible assembly 12 and assisting to maintain stationary with respect to the item being cleaned.

The inlet of the cleaning conduit high pressure hose 32 and the inlet of the thruster conduit high pressure hose 40 are engaged to an outlet of a high pressure hose 42 engaged to a high pressure pump (not shown) located on the land or boat. The high pressure pump pumps the high pressure water to both the cleaning conduit 30 and the thruster conduit 36. An area near the outlet of the high pressure hose 42 may be engaged to the submersible assembly 12 by an engagement device 44 that encircles the high pressure hose and is engaged to the submersible assembly 12. The high pressure hose 42 may be any hose capable of carrying a liquid, wherein the pressure of the water is at least 1,000 psi. The high pressure hose 42 utilized in the present invention is preferably able to withstand a pressure of greater than 3,000 psi and more preferably able to withstand a pressure of at least 6,000 psi.

A weighting system may be attached to the submersible assembly 12 to stabilize the submersible assembly 12 when the submersible assembly 12 is submerged in water. The weighting system may comprise a positioning cable 46 suspended from a stationary element on the land or a boat and into the water below the surface. The positioning cable 46 includes an attachment device 48 on its distal end. A stabilizing weight 50 is attached to the attachment device 48, creating a tension on the positioning cable 46 and resulting in the positioning cable 46 extending vertically downward into the water from the stationary element. The positioning cable 46 extends through a guide eye 52 on the submersible assembly 12. The positioning cable 46 serves as a guide, allowing the submersible assembly 12 to slide vertically along the positioning cable 46. As illustrated, a guide eye 52 is disposed on each transverse member 20 of the upper frame 14 and each transverse member 24 of the lower frame 16. The guide eye 52 is preferably centrally disposed on each transverse member 20 of the upper frame 14 and each transverse member 24 of the lower frame 16. Two positioning cables 46 are disposed on each side of the submersible assembly 12. A first positioning cable 46 is positioned through a guide eye 52 disposed on the transverse member 20 of the upper frame 14 and a transverse member 24 of the lower frame 15 on one side of the submersible assembly 12. On the opposite side of the submersible assembly 12, a second positioning cable 46 is positioned through a guide eye 52 disposed on the transverse member 20 of the upper frame 14 and the transverse member 24 on the lower frame 16. In this arrangement, the first positioning cable 46 is disposed on one side of the submersible assembly 12 and proceeding through both guide eyes 52 disposed on this side of the submersible assembly 12, and a second positioning cable 46 is disposed on the opposite side of the submersible assembly 12 and proceeding through both guide eyes 52 disposed on this side of the submersible assembly 12, allowing the submersible assembly 12 to slide in the vertical direction up and down the first and second positioning cables 46, serving as a guide as the submersible assembly 12 moves vertically within the water.

At least one bracket 54 is disposed on the upper frame 14 for engagement with a corner cable 56. As illustrated, four brackets 54 are disposed on the upper frame, and specifically above the intersection of each longitudinal member 18 and transverse member 20. The brackets 54 extend upwardly from the upper frame 14 and contain a bore that receives the corner cable 56. In one embodiment, a separate corner cable 56 may be engaged to each bracket 54 at one end and the other end is engaged to a lifting cable 58, for raising the submersible assembly 12. The lifting cable 58 is engaged to a motor, winch, or the like (not shown) that is located on land, a davit, or a boat for vertically moving the submersible assembly 12 within the water and lifting the submersible assembly 12 out of the water.

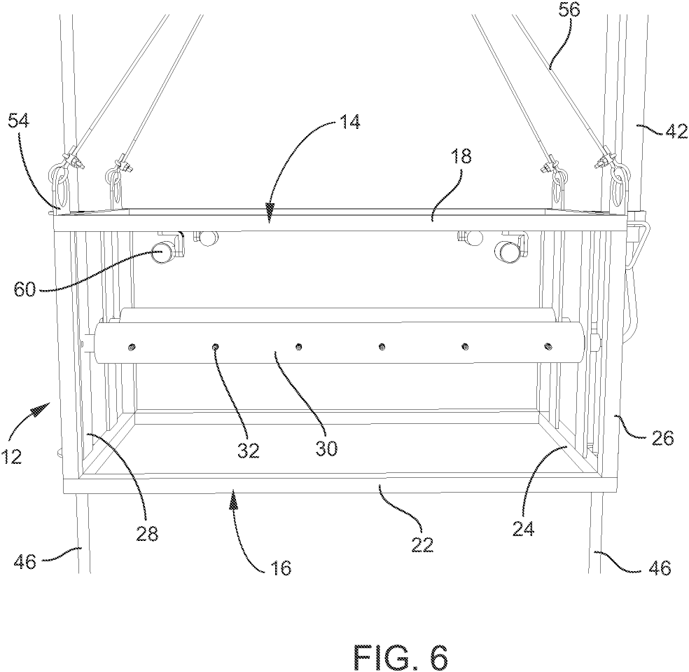

As shown in FIG. 6, at least one camera 60 may be disposed on the submersible assembly, allowing a user to view the submersible assembly 12 and its surroundings from a remote location. The camera 60 transfers the image captured to a visual display, such as a television, monitor, computer, tablet, mobile phone, or the like located at a remote location away from the submersible assembly 12. In one embodiment, the image is viewable to a user operating the device 10 and located in close proximity to the device 10, such as on land or in a boat. The cameras 60 may be battery operated or the requisite power supplied by a power source. When power is supplied by an external power source that is not a battery contained within camera 60, a conduit 62 that is suspended from land or a boat carries a power cord that is engaged to the camera 60, supplying the electrical power needed to operate the camera 60. A transmission cable is also contained within the conduit 62 for transmitting the images captured on the camera 60 to a user at a remote location. At least one light may be engaged to the submersible assembly 12 for allowing easier visibility to a user when the device 10 is submerged in murky or deep water without much or any natural light.

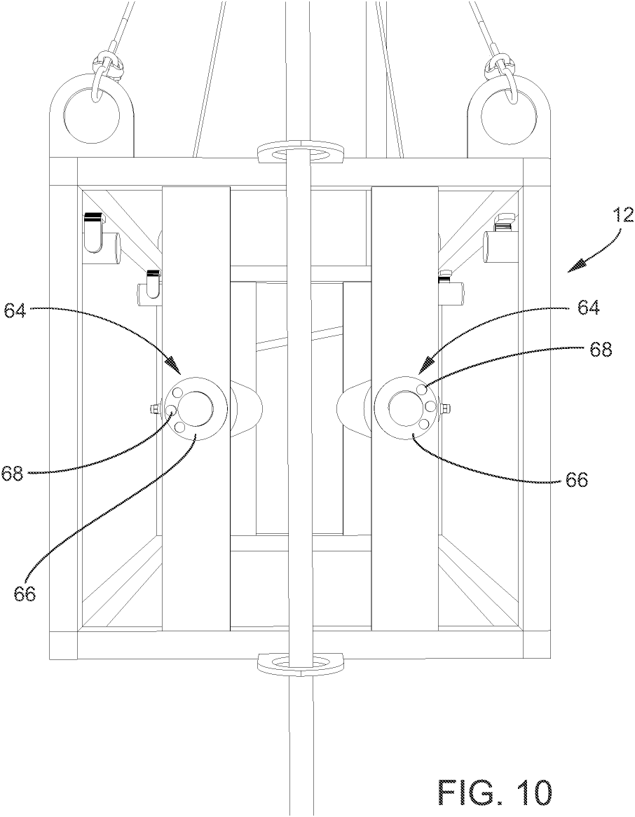

An adjustment mechanism 64 is utilized to adjust the spraying direction of the nozzles 32 on the cleaning conduit 30. As illustrated in FIGS. 10-12, the adjustment mechanism 64 comprises a plate 66 engaged to an end of the cleaning conduit 30 that protrudes through a bore within a vertically extending element 28. The plate 66 contains a centrally located opening and the end of the cleaning conduit 30 is received within the opening, while both ends of the cleaning conduit 30 are rotationally engaged to opposed vertically extending elements 28. The plate 66 contains at least two openings and preferably a plurality of openings. At least one corresponding opening is disposed on the vertically extending element 28. A pin 68 is adapted to act as a stop, whereby the pin 68 is received within the opening on the vertically extending element 28 and an opening on the plate 66, preventing further rotation of the cleaning conduit 30, thereby angling the cleaning nozzles 32 and thus the spray exiting the cleaning nozzles 32. The plate 66 and pin 68 may be composed of solid steel and is of sufficient size and construction to essentially resist permanent deformation if subjected to large shear stresses during use. The adjustment mechanism 64 allows the spray angle of the cleaning nozzles 32 and thruster nozzles 38 to be adjusted relative to the submersible assembly 12. The spray angle of the thruster nozzles 38 is preferably positioned such that the force exerted upon the submersible assembly 12 from the discharge of water from the cleaning nozzles 32 is counteracted by the pressure and spray angle of the discharge of the water from the thruster nozzles 38. Any water current will also be taken into consideration for assisting with the stabilization of the submersible assembly 12 and the spray angle of the cleaning nozzles 32 and thruster nozzles 38.

The submersible assembly 12 may be composed of metal, particularly aluminum or stainless steel, plastic, and the like. The liquid utilized by the device will primarily be water as described herein. However, the liquid may be a mixture of cleaners, such as biodegradable cleaners, and/or organisms mixed with water to aid on cleaning the underwater structure.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An underwater remote cleaning device, comprising:
a submersible assembly;
a cleaning conduit engaged to the submersible assembly with an inlet for receiving a liquid and at least one nozzle disposed on the cleaning conduit for spraying the liquid; and
a thruster conduit engaged to the submersible assembly with an inlet for receiving a liquid and at least one nozzle disposed on the cleaning conduit for spraying the liquid.

2. The underwater remote cleaning device according to claim 1, wherein the submersible assembly is engaged to a positioning cable that is engaged to a stabilizing weight at one end.

3. The underwater remote cleaning device according to claim 1, wherein the submersible assembly is engaged to a first positioning cable and a second positioning cable, the first positioning cable and the second positioning cable are engaged to a stabilizing weight at one end.

4. The underwater remote cleaning device according to claim 1, further comprising at least one bracket engaged to the submersible assembly for receiving a cable for lifting the submersible assembly in the vertical direction.

5. The underwater remote cleaning device according to claim 1, further comprising an adjustment mechanism disposed on an end of the cleaning conduit, allowing the spray angle of the nozzles to be adjusted relative to the submersible assembly.

6. The underwater remote cleaning device according to claim 1, further comprising an adjustment mechanism disposed on an end of the thruster conduit, allowing the spray angle of the nozzles to be adjusted relative to the submersible assembly.

7. The underwater remote cleaning device according to claim 1, further comprising a first high pressure hose engaged to the inlet of the cleaning conduit carrying the liquid and a second high pressure hose engaged to the inlet of the thruster conduit carrying the liquid.

8. The underwater remote cleaning device according to claim 1, further comprising at least one camera engaged to the submersible assembly.

9. An underwater remote cleaning device, comprising:
a submersible assembly having an upper frame and a lower frame spaced-apart from each other and at least one vertically extending element having a first end and a second end, the first end of the vertically extending element is engaged to the upper frame and the second end of the vertically extending element is engaged to the lower frame;
a cleaning conduit disposed within the submersible assembly with an inlet for receiving a liquid and at least one nozzle disposed on the cleaning conduit for spraying the liquid; and
a thruster conduit disposed within the submersible assembly with an inlet for receiving a liquid and at least one nozzle disposed on the cleaning conduit for spraying the liquid.

10. The underwater remote cleaning device according to claim 9, wherein the submersible assembly is engaged to a positioning cable that is engaged to a stabilizing weight at one end.

11. The underwater remote cleaning device according to claim 9, wherein the submersible assembly is engaged to a first positioning cable and a second positioning cable, the first positioning cable and the second positioning cable are engaged to a stabilizing weight at one end.

12. The underwater remote cleaning device according to claim 9, further comprising at least one bracket engaged to the submersible assembly for receiving a cable for lifting the submersible assembly in the vertical direction.

13. The underwater remote cleaning device according to claim 9, further comprising an adjustment mechanism disposed on an end of the cleaning conduit, allowing the spray angle of the nozzles to be adjusted relative to the submersible assembly.

14. The underwater remote cleaning device according to claim 9, further comprising an adjustment mechanism disposed on an end of the thruster conduit, allowing the spray angle of the nozzles to be adjusted relative to the submersible assembly.

15. The underwater remote cleaning device according to claim 9, further comprising at least one camera engaged to the submersible assembly.

16. A method for cleaning an underwater structure, comprising:
providing a submersible assembly, a cleaning conduit engaged to the submersible assembly with an inlet for receiving a liquid and at least one nozzle disposed on the cleaning conduit, and a thruster conduit engaged to the submersible assembly with an inlet for receiving a liquid and at least one nozzle disposed on the cleaning conduit;
positioning the submersible assembly while underwater adjacent a structure to be cleaned;
supplying a liquid to the inlet of the cleaning conduit and the inlet of the thruster conduit;
spraying the liquid from the nozzle of the cleaning conduit at the underwater structure and spraying the liquid from the nozzle of the thruster conduit in a direction opposite the direction of the spray from the cleaning conduit.

17. The method for cleaning an underwater structure according to claim 16, further comprising the submersible assembly engaged to a positioning cable engaged to a stabilizing weight at one end.

18. The method for cleaning an underwater structure according to claim 16, further comprising the submersible assembly engaged to a first positioning cable and a second positioning cable, the first positioning cable and the second positioning cable are engaged to a stabilizing weight at one end.

19. The method for cleaning an underwater structure according to claim 16, further comprising at least one bracket engaged to the submersible assembly for receiving a cable for lifting the submersible assembly in the vertical direction.

20. The method for cleaning an underwater structure according to claim 16, further comprising at least one camera engaged to the submersible assembly.
